(19) United States
(12) Patent Application Publication
(10) Pub. No.: US 2014/0078656 A1
(43) Pub. Date: Mar. 20, 2014

(54) Computer

(71) Applicant: Jonathan Edward Deno, Columbus, OH (US)

(72) Inventor: Jonathan Edward Deno, Columbus, OH (US)

(21) Appl. No.: 13/573,106

(22) Filed: Sep. 20, 2012

(51) Int. Cl. G06F 1/16

(52) U.S. Cl. 361/679.02

(57) ABSTRACT

The Computer is a system built to process data in a timely and orderly fashion.

### CROSS-REFERENCE TO RELATED APPLICATIONS

I have included a copy of the following provisional application for reference: Application No. 61/742,911, filed Aug. 23, 2012.

### BACKGROUND OF THE INVENTION

My invention is The Computer System. My computer can be used to do many things, but all made possible because of the system by which this invention uses and processes data.

### SUMMARY OF THE INVENTION

The structure of My Computer System allows for code to be disassembled and reassembled in a timely and orderly fashion.

### DETAILED DESCRIPTION OF THE INVENTION

While this Computer System can have many applications, a circuit board is a common application. Using a circuit board as an example, a device will send data in the form of instructions. The data will pass through the system, (which for this example is an integrated circuit), and return to either the same device, and/or another device(s). The device will then interpret the instruction, and function accordingly. Software has the capability of sending instructions, communicating with different devices, and even the potential to become a computer system. For these reasons, my Computer commonly relies on the use of software to do many things, and software is often a part of my Computer System.

1. The Computer is a system.

2. The Computer system can process data and support software.
